(19) United States
(12) Patent Application Publication
(10) Pub. No.: US 2019/0279246 A1
(43) Pub. Date: Sep. 12, 2019

(54) MOBILE TERMINAL, SERVER, SYSTEM AND COMMUNICATION METHOD TO MANAGE ATTRACTION RESERVATION

(71) Applicant: Samsung C & T Corporation, Seoul (KR)

(72) Inventors: Dong Hoon Kwak, Gyeonggi-do (KR); Ju Hyun, Seoul (KR); Sung Hun Gwak, Suwon-si (KR); Jae Wook Lee, Gyeonggi-do (KR); Han Eol Yu, Gyeonggi-do (KR); Kang Suk Oh, Yongin-si (KR)

(21) Appl. No.: 15/992,923

(22) Filed: May 30, 2018

(30) Foreign Application Priority Data
Mar. 7, 2018 (KR) 10-2018-0026972

(51) Int. Cl. G06Q 30/02; G06Q 10/02

(52) U.S. Cl. CPC G06Q 30/0231; G06K 19/06037; G06Q 10/02

(57) ABSTRACT

An attraction reservation management system may activate ticket information registered in a mobile terminal in response to an entry based on the ticket information being allowed, may assign a default credit and additional credit-related information to the ticket information in response to an activation of the ticket information, may assign an additional credit based on the additional credit-related information to the ticket information in response to an amount of time elapsing, and may generate attraction reservation information for a target attraction by subtracting credits that are cumulatively assigned to the ticket information.

### CROSS-REFERENCE TO RELATED APPLICATIONS

This application claims the benefit of Korean Patent Application No. 10-2018-0026972, filed on Mar. 7, 2018, in the Korean Intellectual Property Office, the disclosure of which is incorporated herein by reference.

### BACKGROUND

### 1. Field of the Invention

One or more example embodiments relate to a technology associated with a management of an attraction reservation.

### 2. Description of the Related Art

In a place of business that provides offline services, for example, airports, banks, theme parks and restaurants, various methods to minimize an amount of time a customer waits for services are being utilized. To this end, various schemes, for example, an advance reservation, an off-season discount or an activation of a mobile device, may be used. However, due to space constraints in a place of business and inaccurate predictions, customers inevitably need to wait.

Thus, there is a demand for a technology to improve a customer satisfaction by compensating a customer's waiting time and to utilize the waiting time as a service resource.

### BRIEF SUMMARY

According to an aspect, there is provided a mobile device including an input acquirer configured to receive a user input associated with ticket information from a user, a processor configured to activate the ticket information input by the user input in response to an entry based on the ticket information being approved, configured to assign a default credit and additional credit-related information to the ticket information in response to an activation of the ticket information, configured to assign an additional credit to the ticket information in response to an amount of time based on the additional credit-related information elapsing, and configured to generate attraction reservation information for a target attraction by subtracting a cumulative credit calculated by accumulating the default credit and the additional credit, and a memory configured to store the ticket information and the attraction reservation information.

According to another aspect, there is provided a server including a communicator configured to receive an activation request for ticket information registered in a mobile terminal and a reservation request based on a subtraction of credits that are cumulatively assigned to the ticket information from the mobile terminal, and a processor configured to activate the ticket information in response to an entry based on the ticket information being valid, configured to assign a default credit and additional credit-related information to the ticket information in response to an activation of the ticket information, configured to assign an additional credit to the ticket information in response to an amount of time based on the additional credit-related information elapsing, configured to determine whether to approve the reservation request based on a capacity of a target attraction, and configured to generate attraction reservation information for the target attraction in response to the reservation request being approved.

According to another aspect, there is provided an attraction reservation management method including activating ticket information registered in a mobile terminal in response to an entry based on the ticket information being allowed, assigning a default credit and additional credit-related information to the ticket information in response to an activation of the ticket information, assigning an additional credit based on the additional credit-related information to the ticket information in response to an amount of time elapsing, and generating attraction reservation information for a target attraction by subtracting credits that are cumulatively assigned to the ticket information.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIGS. 1A and 1B are diagrams illustrating an attraction reservation management system according to an example embodiment;

FIGS. 2 and 3 illustrate an attraction reservation management method according to an example embodiment;

FIG. 4 is a diagram illustrating a ticket sale, a gate entry and an attraction reservation according to an example embodiment;

FIG. 5 is a diagram illustrating an entry based on ticket information according to an example embodiment;

FIG. 6 is a diagram illustrating a ticket registration according to an example embodiment;

FIG. 7 is a diagram illustrating a transmission of ticket information according to an example embodiment;

FIG. 8 is a flowchart illustrating an assignment of a default credit and setting of an additional credit generation condition;

FIG. 9 is a diagram illustrating a credit-related setting set according to an example embodiment;

FIG. 10 is a diagram illustrating an example of a generation of an additional credit according to an example embodiment;

FIG. 11 is a diagram illustrating a reservation request according to an example embodiment;

FIG. 12 is a diagram illustrating attraction reservation information for an approved reservation request according to an example embodiment;

FIG. 13 is a flowchart illustrating an example of an approval for a reservation according to an example embodiment;

FIG. 14 is a diagram illustrating schedules, time slots and intervals of a target attraction according to an example embodiment;

FIG. 15 is a diagram illustrating credit-related information of a target attraction according to an example embodiment;

FIG. 16 is a diagram illustrating information associated with a probability and a capacity of a target attraction according to an example embodiment;

FIG. 17 is a block diagram illustrating a configuration of a mobile terminal according to an example embodiment; and

FIG. 18 is a block diagram illustrating a configuration of a server according to an example embodiment.

### DETAILED DESCRIPTION

Hereinafter, example embodiments will be described in detail with reference to the accompanying drawings. The scope of the right, however, should not be construed as limited to the example embodiments set forth herein. Various modifications may be made to the example embodiments. Here, the examples are not construed as limited to the disclosure and should be understood to include all changes, equivalents, and replacements within the idea and the technical scope of the disclosure.

The terminology used herein is for the purpose of describing particular embodiments only and is not intended to be limiting. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Regarding the reference numerals assigned to the elements in the drawings, it should be noted that the same elements will be designated by the same reference numerals, wherever possible, even though they are shown in different drawings. Also, in the description of example embodiments, detailed description of well-known related structures or functions will be omitted when it is deemed that such description will cause ambiguous interpretation of the present disclosure.

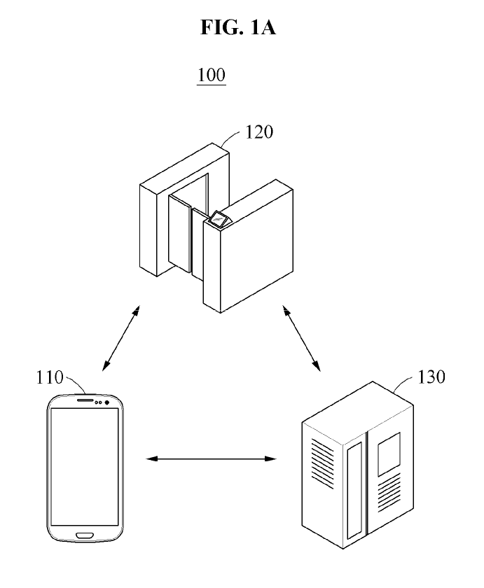

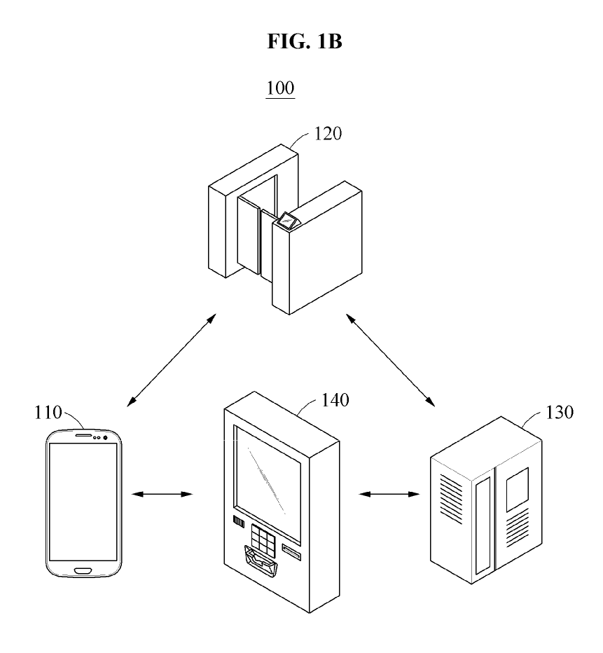

FIGS. 1A and 1B are diagrams illustrating an attraction reservation management system 100 according to an example embodiment.

The attraction reservation management system 100 may include a communication terminal 110 (hereinafter, referred to as a “mobile terminal 110”) for an attraction reservation, an entry gate 120, and a communication server 130 (hereinafter, referred to as a “server 130”) for an attraction reservation.

The mobile terminal 110 may refer to a terminal used for an entry to a service space and a use of an attraction. The service space may refer to a space in which a service is provided by a service provider, and the attraction may refer to a facility included in the service space. For example, the service space may be a theme park and the attraction may be a ride, however, this is merely an example, and the service space and the attraction are not limited thereto. For example, the service space may be a space including an attraction in which a queue may be generated, for example, a museum, an exhibition hall, a memorial hall, an aquarium and an amusement arcade.

The mobile terminal 110 may store and execute a reservation management application for an entry to a service space and a use of an attraction. The reservation management application may be an application designed to send a reservation request for an attraction to the server 130 and may be stored in a memory of the mobile terminal 110. The mobile terminal 110 may include, for example, a smart device such as a smartphone, however, is not limited thereto. For example, the mobile terminal 110 may be implemented as a wearable device. The wearable device may be a portable electronic device that may be attached to or placed on a user's body.

The mobile terminal 110 may store ticket information and may provide the stored ticket information to the server 130 to allow a user to enter the service space. For example, the mobile terminal 110 may store the ticket information using the reservation management application. The mobile terminal 110 may store the ticket information in a memory region assigned to the reservation management application. A user may show the ticket information at the entry gate 120 of the service space using a display of the mobile terminal 110 to enter the service space. Also, the mobile terminal 110 may map a variety of additional information to the ticket information. The additional information may be used to use an attraction. For example, the mobile terminal 110 may map a credit as additional information and may allow a user to make a reservation for an attraction in an arbitrary time slot using the mapped credit.

In the present disclosure, ticket information may refer to data indicating a ticket that may allow a user to enter a service space. The ticket information may be expressed by, for example, a serial number, a one-dimensional (1D) code (for example, a barcode) corresponding to the serial number, a two-dimensional (2D) code (for example, a QR code) corresponding to the serial number, a Radio-frequency identification (RFID), or biometric information (for example, a face or a fingerprint). For example, when a ticket is a group ticket (for example, a family ticket or an organization ticket), a personal ticket may be issued for each of individuals of a corresponding group and ticket information may be managed for each personal ticket.

For example, the mobile terminal 110 may register ticket information based on a user input. When an arbitrary condition is satisfied, the mobile terminal 110 may accumulate credits in the registered ticket information, may consume the accumulated credits and may send a reservation request for a target attraction to the server 130. When a reservation for the target attraction is approved by the server 130, the mobile terminal 110 may generate attraction reservation information based on data received from the server 130.

The entry gate 120 may refer to gates installed at an entrance and an exit of a service space. The entry gate 120 may recognize ticket information stored in the mobile terminal 110 and may transmit the ticket information to the server 130. In an example, the mobile terminal 110 may display the ticket information in a form of a 2D code (for example, a QR code), and the entry gate 120 may read the ticket information from the QR code and may transmit the ticket information to the server 130. In another example, the mobile terminal 110 and the entry gate 120 may establish a wireless communication, and the entry gate 120 may receive the ticket information from the mobile terminal 110 via the wireless communication and may transmit the ticket information to the server 130. However, a recognition of ticket information by the entry gate 120 is not limited thereto, and may vary depending on a design.

The server 130 may manage a use of an attraction and an entry to a service space by a user of the mobile terminal 110. For example, when ticket information stored in the mobile terminal 110 is valid, the server 130 may activate the ticket information. When ticket information in the mobile terminal 110 recognized by the entry gate 120 is valid, the server 130 may approve an entry via the entry gate 120. For example, the server 130 may transmit an entry approval command to the entry gate 120 that recognizes the valid ticket information.

Also, the server 130 may process a reservation request that is based on a subtraction of credits that are cumulatively assigned to the ticket information. For example, the server 130 may determine whether to approve the reservation request based on a time slot and a capacity of the target attraction. When the reservation request is approved, the server 130 may generate attraction reservation information for a target attraction and may provide the attraction reservation information as ticket information to the mobile terminal 110.

A target attraction may refer to an attraction a user desires to use among attractions located in a service space. For example, the target attraction may be an attraction selected from a plurality of attractions in response to a user input. The user input may refer to an input acquired in response to a user operating the mobile terminal 110. The user input may include, for example, a touch input acquired in response to a touch on a touch screen of the mobile terminal 110.

Although the mobile terminal 110, the entry gate 120 and the server 130 are illustrated in FIG. 1A, example embodiments are not limited thereto. For example, the attraction reservation management system 100 may further include an intermediate terminal 140 configured to relay a communication between the mobile terminal 110 and the server 130, as shown in FIG. 1B.

The intermediate terminal 140 may be a stationary terminal located in an arbitrary location associated with a service space and may be implemented as, for example, a compact installed type digital terminal with a touch panel. The compact installed type digital terminal may include, for example, an interactive kiosk. The intermediate terminal 140 may relay data exchanged between the mobile terminal 110 and the server 130. For example, the mobile terminal 110 may transfer, via the intermediate terminal 140, ticket information and a reservation request to the server 130. The server 130 may transfer, via the intermediate terminal 140, a default credit, additional credit-related information and attraction reservation information to the mobile terminal 110.

When the mobile terminal 110 is a wearable device, the mobile terminal 110 may transmit data (for example, ticket information) to the intermediate terminal 140 via a near field communication (NFC). The intermediate terminal 140 may transfer the data received from the mobile terminal 110 to the server 130. Also, the intermediate terminal 140 may transfer data received from the server 130 to the mobile terminal 110 via, for example, the NFC. The mobile terminal 110 may display code information (for example, a QR code) corresponding to ticket information on a display, and the intermediate terminal 140 may recognize the ticket information through an optical recognition. The intermediate terminal 140 may also transmit the recognized ticket information to the server 130.

Also, the intermediate terminal 140 may acquire and process a user input (for example, a touch input). For example, in response to an acquisition of a user input, the intermediate terminal 140 may generate a reservation request that is based on a credit assigned to the ticket information received from the mobile terminal 110. In this example, the mobile terminal 110 may merely provide the ticket information to the intermediate terminal 140, and the intermediate terminal 140 may perform the other operations of an attraction reservation management method.

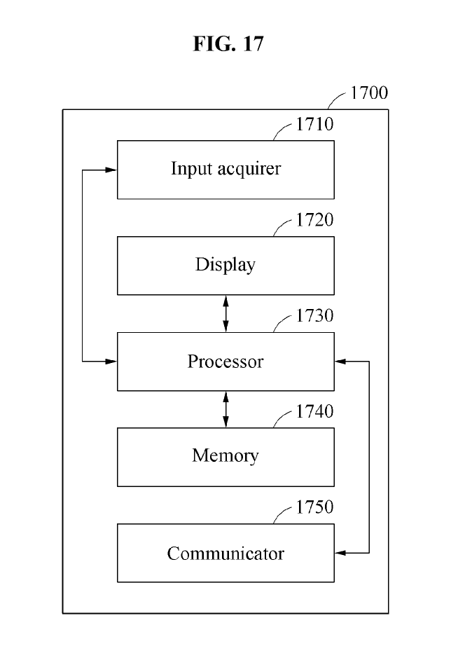

Although an example in which a direct communication between the mobile terminal 110 and the server 130 is established will be mainly provided in the following description, example embodiments are not limited thereto. For example, an indirect communication between the mobile terminal 110 and the server 130 may be established via the intermediate terminal 140. Also, although an example in which the mobile terminal 110 verifies a credit and performs a reservation based on the credit in the attraction reservation management method will be mainly provided in the following description, example embodiments are not limited thereto. For example, the intermediate terminal 140 may perform operations of the mobile terminal 110 that will be described below. The intermediate terminal 140 may be configured similarly to a mobile terminal 1700 of FIG. 17. For example, when a user wears a wearable device that has a simple function as the mobile terminal 110, the user may make a reservation by simply sending ticket information to the intermediate terminal 140 using the wearable device. Also, the intermediate terminal 140 may provide a reservation interface with an excellent readability and convenience through a screen that is larger in size than the mobile terminal 110.

For example, the attraction reservation management system 100 may be implemented in various service spaces customers visit. The attraction reservation management system 100 may provide a reservation service, a management of credits for the reservation service, an entry confirmation and a reservation request to all customers who need to wait in a predetermined space to receive provided services.

The attraction reservation management system 100 may provide a default credit when a customer is determined to enter a service space based on ticket information. The attraction reservation management system 100 may provide an additional credit at every predetermined time while the ticket information is valid. The attraction reservation management system 100 may send a reservation request by a subtraction of credits. The attraction reservation management system 100 may determine whether to approve a reservation request based on a predetermined condition. The attraction reservation management system 100 may disperse users within a reserved time period.

For example, the attraction reservation management system 100 may provide a customer with a reservation opportunity for an attraction by assigning a default credit to ticket information. Also, the attraction reservation management system 100 may provide the customer with an additional reservation opportunity by assigning an additional credit to the ticket information. The attraction reservation management system 100 may efficiently reduce a user's waiting time by providing a reservation opportunity based on a credit. The attraction reservation management system 100 may continue to assign additional credits to the ticket information while the ticket information is valid, to more efficiently reduce a customer's waiting time during an operating hour of the service space. When a customer has sufficient credits, the attraction reservation management system 100 may enable an additional reservation to provide an opportunity to reduce a waiting time of the customer. The attraction reservation management system 100 may efficiently distribute a customer's waiting time within restricted resources based on a probability and a capacity of an attraction. The attraction reservation management system 100 may approve credit-based reservations on a first-come-first-serve basis, to distribute a customer's waiting time using a fair and efficient scheme.

Hereinafter, a method by which the attraction reservation management system 100 manages a user's queue for an attraction is described.

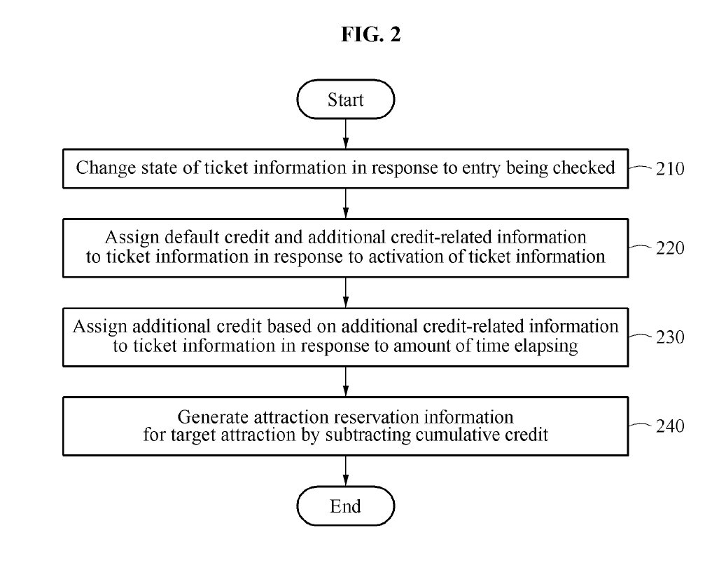

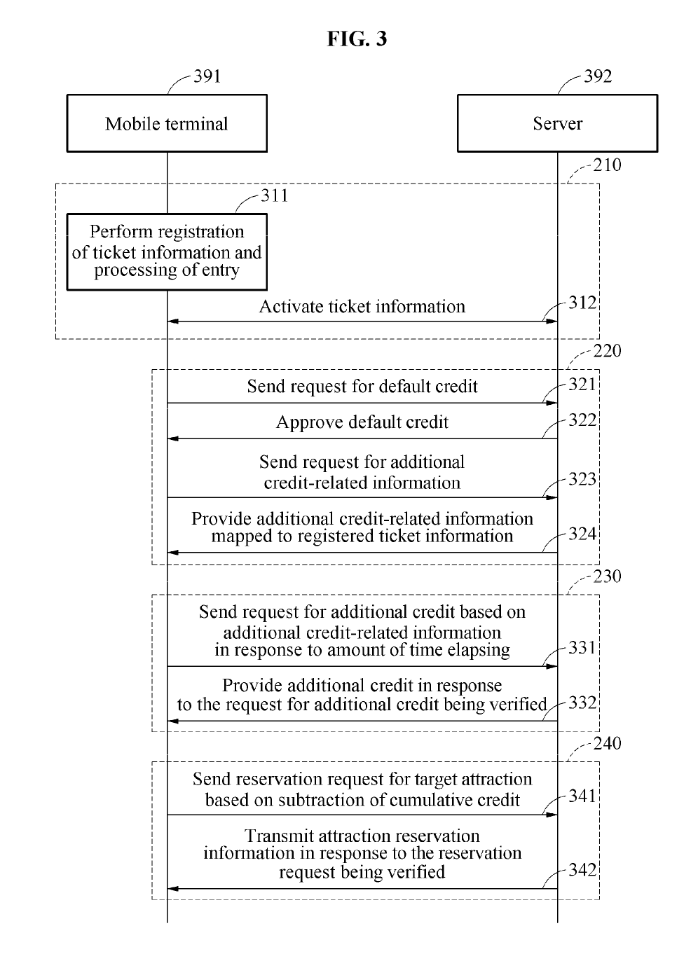

FIGS. 2 and 3 illustrate an attraction reservation management method according to an example embodiment.

FIG. 2 is a flowchart illustrating an operation of an attraction reservation management system.

In operation 210, the attraction reservation management system may change a state of ticket information in response to an entry being checked. For example, the attraction reservation management system may activate the ticket information in response to an entry based on the ticket information registered in a mobile terminal being allowed.

In operation 220, the attraction reservation management system may assign a default credit and additional credit-related information to the ticket information in response to an activation of the ticket information. When an entry based on the ticket information is approved, the attraction reservation management system may activate the ticket information. For example, the attraction reservation management system may change the state of the ticket information to an active state. In the attraction reservation management system, the mobile terminal may send, to a server, a request for a default credit and additional credit-related information determined based on attribute information of the ticket information. In response to the request being approved by the server, the mobile terminal may assign the default credit and the additional credit-related information to the ticket information.

In the present disclosure, a credit may refer to a point used for a reservation for a target attraction. The default credit may refer to a credit assigned to ticket information at a point in time at which ticket information is activated, and may be assigned to ticket information once at a time of a first entry.

The additional credit-related information may be information associated with an additional credit and may include a credit generation amount and a credit generation period in which an additional credit is added to the ticket information. The additional credit-related information may be determined based on the attribute information of the ticket information. The attribute information of the ticket information may include, for example, a class of a ticket (for example, a general ticket or a VIP ticket), a type of tickets (for example, a day pass or an annual membership), and age categories of customers (for example, children, youth, adults, and senior).

In operation 230, the attraction reservation management system may assign an additional credit based on the additional credit-related information to the ticket information in response to an amount of time elapsing.

The additional credit may refer to a credit that is additionally assigned to the ticket information every time a predetermined period elapses after the ticket information is activated. The attraction reservation management system may combine and accumulate the default credit and the additional credit. In the present disclosure, credits including a default credit and an additional credit may be referred to as a “cumulative credit.” The cumulative credit may be used for a reservation for a target attraction.

In operation 240, the attraction reservation management system may generate attraction reservation information for the target attraction by subtracting the cumulative credit. For example, the attraction reservation management system may determine whether to approve a reservation request corresponding to a subtraction of the cumulative credit. When the reservation request is approved, the attraction reservation management system may generate the attraction reservation information and may notify the user of the attraction reservation information.

The attraction reservation information may refer to information indicating a completion of a reservation for the target attraction, and may include, for example, a target attraction to be reserved, a reserved time slot, a reserved interval, a reserved number of people, a reserved serial number, a 1D code (for example, a barcode) indicating a reservation serial number, a 2D code (for example, a QR code) indicating a reservation serial number, and biometric information. However, the attraction reservation information is not limited thereto.

FIG. 3 illustrates examples of operations of a mobile terminal 391 and operations of a server 392. Also, FIG. 3 illustrates examples of the above-described operations 210, 220, 230 and 240 of FIG. 2.

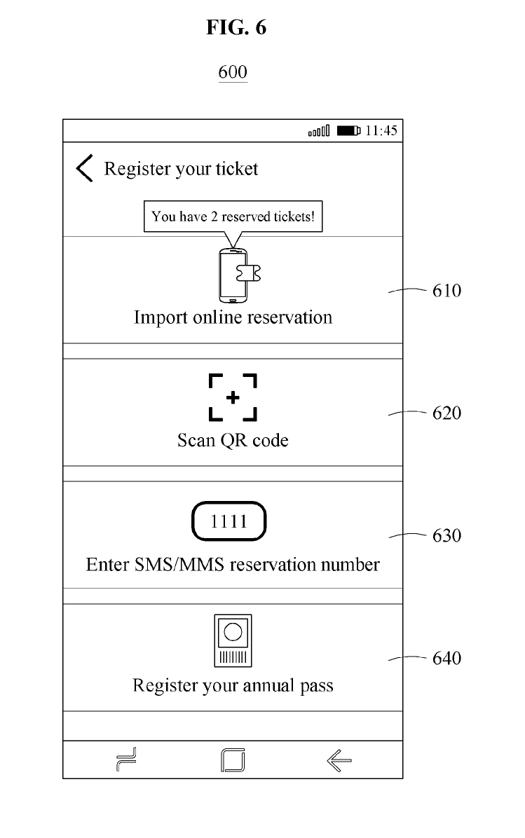

In operation 311, the mobile terminal 391 may perform registration of the ticket information and processing of an entry. For example, the mobile terminal 391 may register the ticket information in response to a user input. The mobile terminal 391 may store the registered ticket information in a memory. As described above with reference to FIGS. 1A and 1B, the mobile terminal 391 may transfer the ticket information to an entry gate through an optical recognition or a wireless communication, and the server 392 may verify a validity of the ticket information received through the entry gate. In response the ticket information being verified to be valid, the server 392 may permit an entry that is based on the ticket information. The registration of the ticket information will be further described below with reference to FIG. 6.

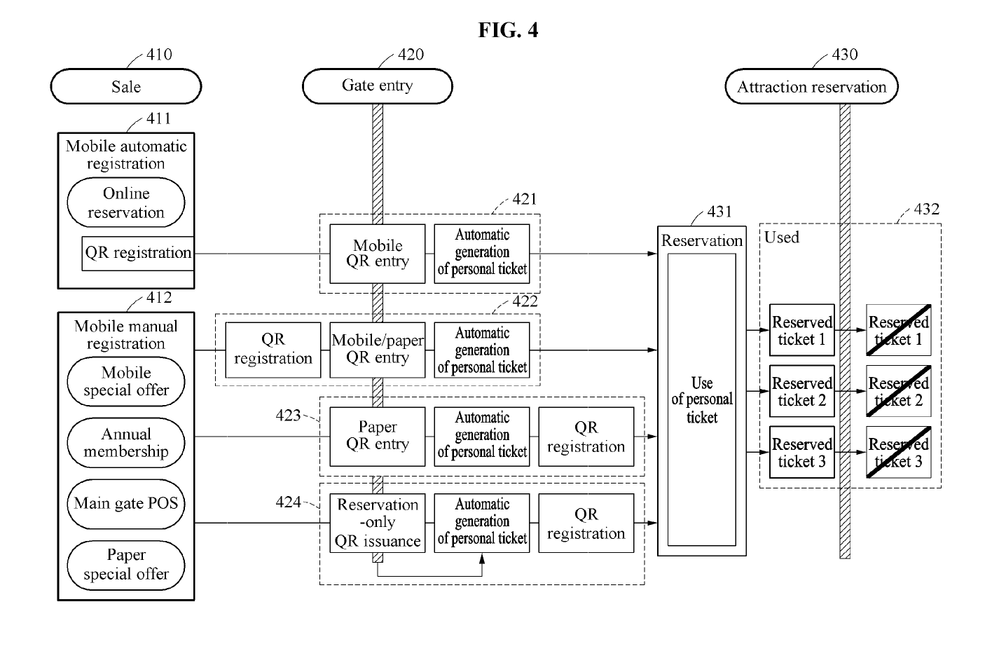

In operation 312, the mobile terminal 391 may activate the ticket information. For example, the server 392 may transmit an activation command to the mobile terminal 391 in response to the ticket information being valid. In response to the activation command being received, the mobile terminal 391 may change a state of the ticket information to an active state. Each state of the ticket information will be described below with reference to FIG. 4.

In operation 321, the mobile terminal 391 may send a request for a default credit to the server 392. For example, the mobile terminal 391 may send a request for a default credit based on attribute information of the ticket information. In operation 322, the server 392 may approve the default credit requested by the mobile terminal 391. The mobile terminal 391 may add the approved default credit to the ticket information. However, example embodiments are not limited thereto. For example, the mobile terminal 391 may transmit the ticket information to the server 392 instead of sending the request for the default credit, the server 392 may determine a default credit based on the ticket information, and the mobile terminal 391 may receive the default credit from the server 392.

In operation 323, the mobile terminal 391 may send a request for additional credit-related information to the server 392. In operation 324, the server 392 may provide additional credit-related information mapped to the registered ticket information. For example, the server 392 may determine additional credit-related information corresponding to the attribute information of the ticket information. The server 392 may provide the mobile terminal 391 with a credit generation period and a credit generation amount that are associated with an additional credit and that are determined based on the attribute information. The mobile terminal 391 may receive, from the server 392, additional credit-related information indicating the credit generation period and the credit generation amount.

In operation 331, the mobile terminal 391 may send a request for an additional credit that is based on the additional credit-related information in response to an amount of time elapsing. For example, the mobile terminal 391 may send, to the server 392, a request for an additional credit that is based on the credit generation amount every time the credit generation period elapses from a point in time at which the ticket information is activated. In operation 332, the server 392 may provide the additional credit in response to the request for the additional credit being verified. For example, the server 392 may verify the request for the additional credit based on a comparison between a point in time at which the request for the additional credit is received from the mobile terminal 391 and the credit generation period counted by the server 392, and based on a comparison between a credit amount requested by the mobile terminal 391 and a credit generation amount that is internally managed in the server 392. The mobile terminal 391 may assign an additional credit corresponding to the credit generation amount to the ticket information every time the credit generation period elapses from the point in time at which the ticket information is activated, based on the additional credit-related information. However, example embodiments are not limited thereto. For example, the server 392 may autonomously assign an additional credit to ticket information registered in the mobile terminal 391 every time a credit generation period elapses from a point in time at which each ticket information is activated.

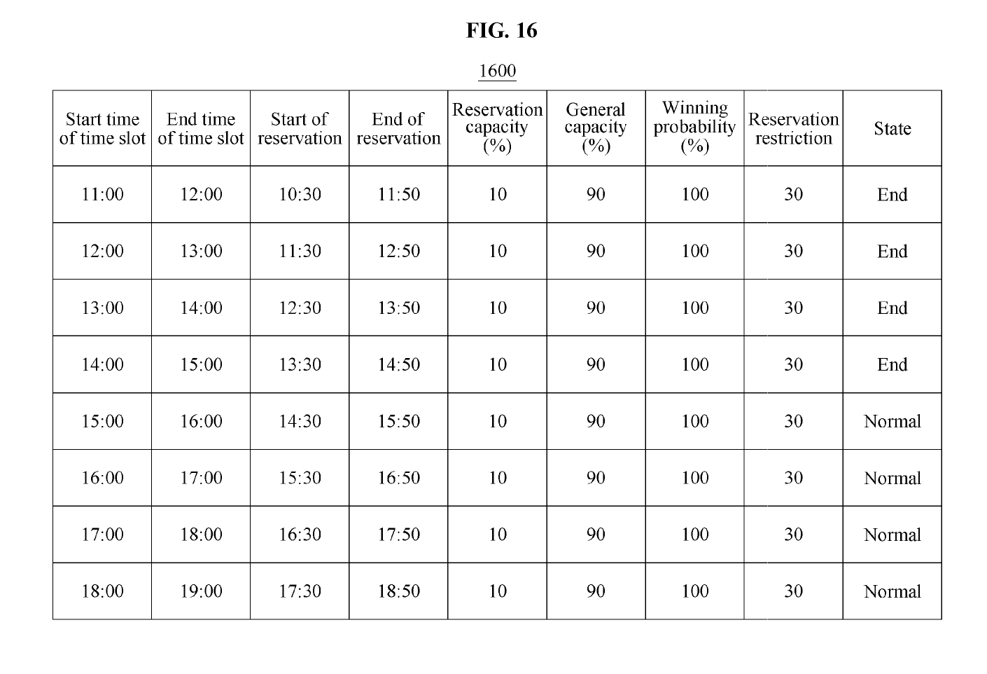

In operation 341, the mobile terminal 391 may send a reservation request for a target attraction based on a subtraction of a cumulative credit. For example, in response to a user input, the mobile terminal 391 may subtract at least a portion of credits that are cumulatively assigned to the ticket information and may transmit the reservation request together with information indicating an amount of subtracted credits to the server 392. In this example, the mobile terminal 391 may determine an amount of credits to be subtracted for the reservation request in response to a user input. The amount of credits to be subtracted may have an influence on a winning probability, which will be described below with reference to FIG. 16. In operation 342, the server 392 may transmit attraction reservation information to the mobile terminal 391 in response to the reservation request being verified. For example, when a capacity of the target attraction is sufficient for a time slot indicated by the reservation request, the server 392 may generate attraction reservation information and transmit the attraction reservation information to the mobile terminal 391.

The operations of the mobile terminal 391 and the server 392 in FIGS. 2 and 3 are merely examples and are not limited thereto. The operations of the mobile terminal 391 and the server 392 will be further described below.

FIG. 4 illustrates a ticket sale, a gate entry and an attraction reservation according to an example embodiment.

An attraction reservation management system may perform a ticket sale operation 410, a gate entry operation 420 and an attraction reservation operation 430.

The ticket sale operation 410 may refer to selling of a ticket issued by a service provider. Through the ticket sale operation 410, a ticket provided to a user may be automatically or manually registered in a mobile terminal. The automatically registering of the ticket and the manually registering of the ticket are illustrated in blocks 411 and 412 of FIG. 4.

In an example, as shown in the block 411, a user may register ticket information in a mobile terminal through an online reservation, and the mobile terminal may automatically register a QR code. In this example, the ticket information registered in the mobile terminal may be activated by the gate entry operation 420. In FIG. 4, ticket information that is registered prior to the gate entry operation 420 may be activated through a first activation process 421. For example, in the first activation process 421, when an entry using a QR code is checked, a personal ticket may be automatically generated.

In another example, as shown in the block 412, a user may acquire a ticket through a mobile special offer, an annual membership, a point of sale (POS) at a main gate of a service space, and a paper special offer. In this example, ticket information may be manually registered in a mobile terminal based on a user input. For example, in a second activation process 422, the mobile terminal may store ticket information by recognizing a QR code based on a user input prior to the gate entry operation 420 as indicated by “QR registration” in FIG. 4. When an entry using on a mobile QR code or a paper QR code corresponding to the ticket information is checked, a personal ticket may be automatically generated. In a third activation process 423, when a personal ticket is automatically generated by an entry using a paper QR code, the mobile terminal may register the ticket information by recognizing the paper QR code in response to a user input as indicated by “QR registration” in FIG. 4. In a fourth activation process 424, when a service provider issues an arbitrary QR code at a gate as indicated by “reservation-only QR issuance” in FIG. 4, a personal ticket corresponding to the QR code may be automatically generated, and the mobile terminal may register ticket information corresponding to the QR code by recognizing the QR code in response to a user input as indicated by “QR registration” in FIG. 4.

In the present disclosure, a personal ticket may refer to a ticket issued to a user of a mobile terminal in which ticket information is registered. For example, when ticket information is associated with a group ticket, personal tickets identified for each individual mobile terminal may be issued. A ticket identifier (ID) may be issued for each of the personal tickets. The attraction reservation management system may classify and manage credits for each of the personal tickets.

The first activation process 421, the second activation process 422, the third activation process 423, and the fourth activation process 424 are merely examples, and are not limited to those described above. Although a personal ticket is issued only when both a registration of ticket information and processing of an entry are performed by the mobile terminal as described above, example embodiments are not limited thereto. For example, the attraction reservation management system may perform one of the registration of the ticket information and the processing of the entry. In response to the ticket information being registered in the mobile terminal, the attraction reservation management system may issue a personal ticket before an entry. In response to an entry based on arbitrary ticket information being processed, the attraction reservation management system may issue a personal ticket even though the ticket information is not registered in the mobile terminal.

In response to at least one of a registration of ticket information and an entry by ticket information being performed by the mobile terminal, the attraction reservation management system may change a state of the ticket information to an active state. For example, when an entry by ticket information is valid, a server may change a state of the ticket information from a valid state to an active state.

In the present disclosure, state information of ticket information may be classified into a stock state, a valid state, an active state and a void state. The stock state may refer to a state of a ticket that is issued by a service provider, but that is not used, and may indicate, for example, that a ticket is managed as a stock among pre-issued tickets. The valid state may refer to a state of a ticket that is issued to enable an entry, and may indicate, for example, that a ticket is purchased but has not been used yet. The active state may refer to a state of a ticket indicating that an entry is completed, and may indicate, for example, a mobile ticket representing that an entry is processed. The void state may refer to a state of a ticket that is not available, and may indicate, for example, a ticket that has expired or is invalid. For example, in a valid state or an active state, ticket information may be registered in the mobile terminal.

When an entry is checked, the attraction reservation management system may assign a default credit and additional credit-related information to the ticket information. A customer may use a reservation service for an attraction based on a cumulative credit. An amount of credits to be accumulated may increase over time, and thus the attraction reservation management system may provide more reservation opportunities to a user.

In the attraction reservation operation 430, the mobile terminal may use a personal ticket in response to a user input as shown in a block 431. For example, the mobile terminal may send a reservation request for a target attraction to the server using credits credited in the personal ticket. When the reservation request is approved by the server, the mobile terminal may acquire attraction reservation information (for example, a reserved ticket).

A user may use the target attraction based on the attraction reservation information stored in the mobile terminal. For example, when the attraction reservation information is used, the attraction reservation management system may change a state of the attraction reservation information to a “used” state as shown in a block 432. Also, the attraction reservation management system may remove the attraction reservation information used as shown in the block 432 from the mobile terminal.

In response to the mobile terminal being out of a region defined as a service space, a processor of the mobile terminal may deactivate the ticket information. The mobile terminal may continuously or periodically monitor a current location. When the mobile terminal is located outside the service space, it may be determined that a user has left the service space. Thus, the mobile terminal may change a state of ticket information of the mobile terminal that is out of the service space to a void state. When a ticket deactivation command is received from the server, the mobile terminal may also change a state of ticket information to a void state. Also, the server may deactivate the ticket information in response to a service end time elapsing.

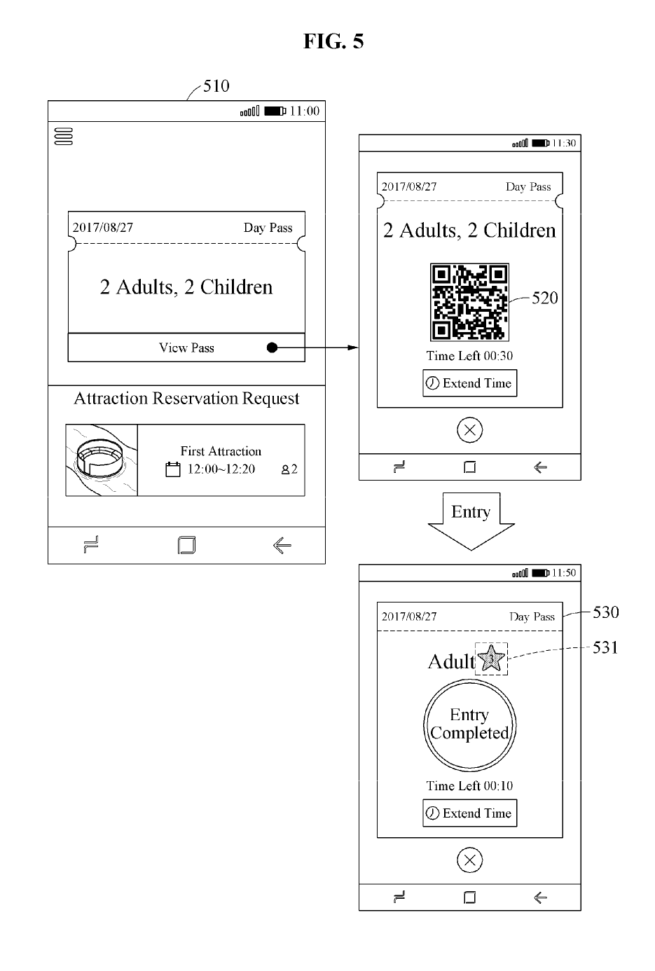

FIG. 5 illustrates an entry based on ticket information according to an example embodiment.

State information of ticket information may be changed by an entry. FIG. 5 illustrates an example in which ticket information is displayed on a mobile terminal based on each state information.

A mobile terminal may register and manage tickets corresponding to a day pass and an annual pass in an attraction reservation management application. The mobile terminal may simplify and display, using a ticket information interface 510, attribute information (for example, a day pass, 2 adults, 2 children, and a date) of ticket information, as shown in FIG. 5. For example, when an annual pass is registered in the mobile terminal, an attraction reservation management system may issue a temporary personal ticket that is valid during a corresponding date.

Before an entry is checked, the mobile terminal may visualize code information 520 corresponding to the ticket information based on a user input associated with a ticket visualization object (for example, “View Pass” in FIG. 5). The code information 520 may be information about a code used for an entry, and the code may include, for example, a 1D code (for example, a barcode) and a 2D code (for example, a QR code).

When the entry is checked, the mobile terminal may visualize ticket information 530 in an active state based on a user input associated with a ticket visualization object. The mobile terminal may visualize a cumulative credit 531 together with the ticket information 530, as shown in FIG. 5.

FIG. 6 illustrates a ticket registration according to an example embodiment.

A mobile terminal may register ticket information indicating a ticket using a variety of schemes. In an example, the mobile terminal may automatically register a ticket purchased using an attraction reservation management application in response to a user input associated with an online reservation object 610 of FIG. 6. In another example, the mobile terminal may register a code (for example, a QR code) appearing on another terminal (for example, a computer) and a paper ticket in response to a user input associated with a code scanning object 620. In another example, the mobile terminal may register a ticket serial number transferred to a user via a text message (for example, a short message service (SMS) and a multimedia message service (MMS)) in response to a user input associated with a number registration object 630. In another example, the mobile terminal may register ticket information in response to a user input associated with an annual pass registration object 640.

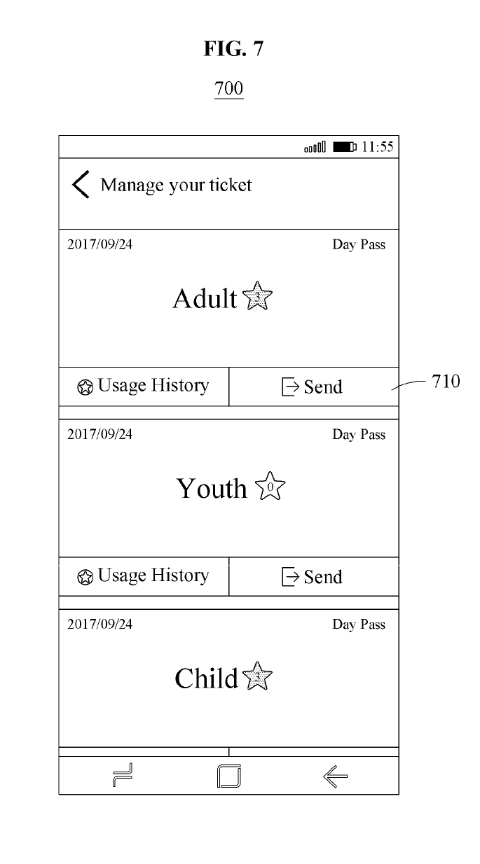

FIG. 7 illustrates a transmission of ticket information according to an example embodiment.

Referring to FIG. 7, a mobile terminal may register ticket information corresponding to each of a plurality of tickets in an attraction reservation management application. In response to a user input associated with a “Send” object 710, the mobile terminal may send ticket information that is currently registered in the mobile terminal to another user terminal.

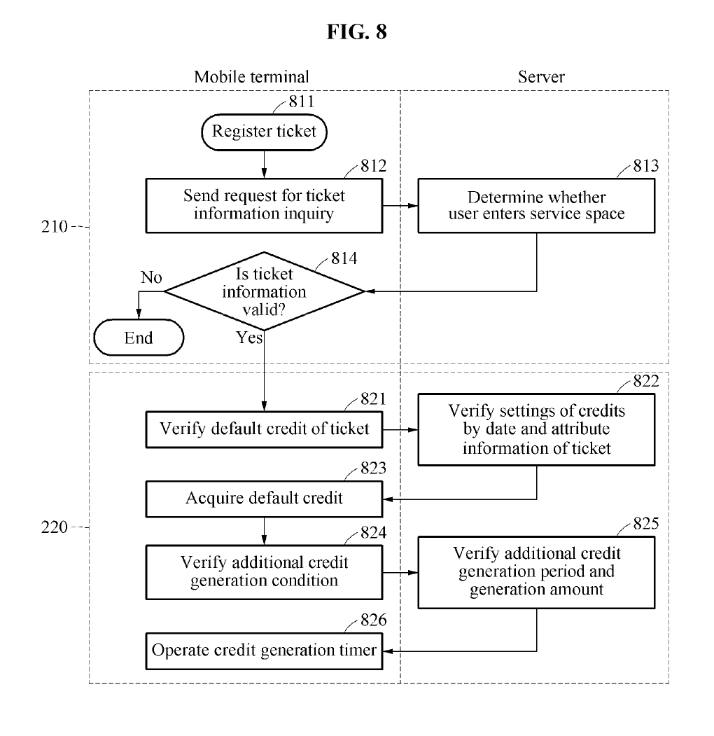

FIG. 8 is a flowchart illustrating an assignment of a default credit and setting of an additional credit generation condition.

FIG. 8 is an example of operations 210 and 220 of FIG. 2.

In operation 811, a mobile terminal may register a ticket, as described above.

In operation 812, the mobile terminal may send, to a server, a request for inquiry on ticket information corresponding to the registered ticket. In operation 813, the server may determine whether a user enters a service space based on the ticket information. For example, the server may determine whether the ticket is already used. When the ticket is unused, the server may verify that the ticket information is valid. When the ticket is already used or has expired, the server may verify that the ticket information is invalid.

In operation 814, the mobile terminal may determine whether the ticket information is verified to be valid by the server. When the ticket information is invalid, the mobile terminal may terminate processing of the ticket information.

In response to the ticket information being verified to be valid by the server, the mobile terminal may verify a default credit of the ticket in operation 821. For example, the mobile terminal may request the server to assign a default credit to the ticket information. In operation 822, the server may verify settings of credits by date and attribute information of the ticket. For example, the server may determine the default credit based on a date of an entry and the attribute information of the ticket. In operation 823, the mobile terminal may acquire the default credit determined by the server.

In operation 824, the mobile terminal may verify an additional credit generation condition. For example, the mobile terminal may send a request for additional credit-related information to the server. In operation 825, the server may verify an additional credit generation period and an additional credit generation amount. The server may determine the additional credit-related information based on at least one of a date and attribute information of the ticket information and may assign the determined additional credit-related information to the ticket information. For example, the server may determine a credit generation period and a credit generation amount based on attribute information of the ticket information. In response to a date of an entry being within a period of an event, the server may determine a credit generation period and a credit generation amount assigned to the event period.

In operation 826, the mobile terminal may operate a credit generation timer. For example, the mobile terminal may measure an amount of time that elapses after an activation of the ticket information and may cumulatively assign addition credits to the ticket information for each credit generation period determined by the server.

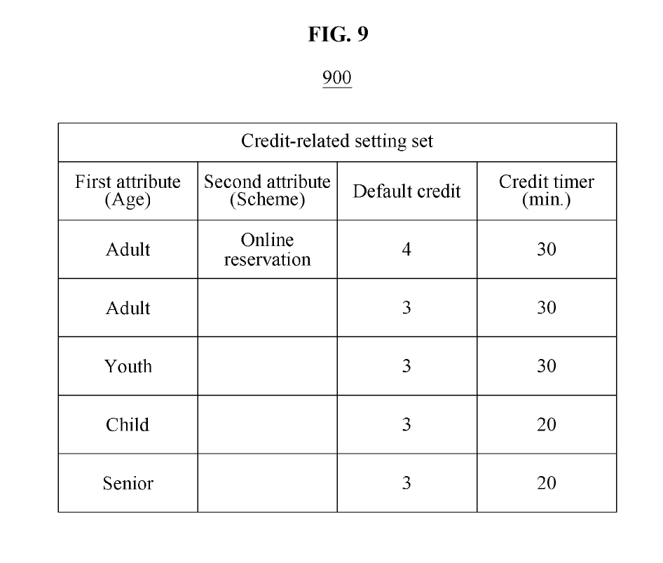

FIG. 9 illustrates a credit-related setting set 900 according to an example embodiment.

A server may store the credit-related setting set 900. The credit-related setting set 900 may show a default credit and additional credit-related information provided based on attribute information of ticket information. The server may assign the default credit, and a credit generation period and a credit generation amount for an additional credit based on the credit-related setting set 900.

For example, FIG. 9 shows age categories of customers and reservation schemes as attribute information. When ticket information indicates a ticket purchased via an “online reservation” for an “adult”, the server may assign “4” as a default credit to the ticket information and may set a credit timer for generation of an additional credit to 30 minutes. For other attribute information, the server may also determine a default credit and additional credit-related information based on the credit-related setting set 900. For example, when attribute information of ticket information indicates “Child”, the server may assign “3” as a default credit to the ticket information and may set the credit timer to 20 minutes.

Although the credit-related setting set 900 is stored by the server, example embodiments are not limited thereto. For example, a mobile terminal may store the credit-related setting set 900. Also, the credit-related setting set 900 is merely an example and is not limited to that shown in FIG. 9.

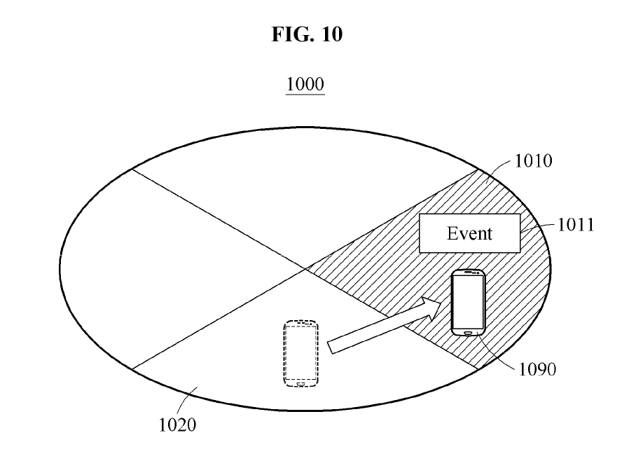

FIG. 10 illustrates an example of a generation of an additional credit according to an example embodiment.

FIG. 10 illustrates a service space 1000, and an event region 1010 and a region 1020 into which the service space 1000 is divided. An attraction reservation management system may adjust a credit assigned to ticket information or may provide a credit, based on an event 1011.

For example, while the mobile terminal 1090 is located within the event region 1010, the mobile terminal 1090 may adjust at least one of a credit generation period and a credit generation amount provided to ticket information. In response the mobile terminal 1090 moving from the region 1020 to the event region 1010 in the service space 1000, the mobile terminal 1090 may adjust a credit generation period and a credit generation amount for an additional credit. While the mobile terminal 1090 is within the event region 1010, the mobile terminal 1090 may reduce the credit generation period and increase the credit generation amount. When the mobile terminal 1090 is out of the event region 1010, the mobile terminal 1090 may recover the credit generation period and the credit generation amount for the additional credit.

In the present specification, the event region 1010 may refer to a region in which the event 1011 occurs within the service space 1000. The event 1011 may refer to an event defined by a service provider in association with an additional credit, and may include, for example, an event that increases an additional credit while being within a region in the service space 1000 to promote the region. The attraction reservation management system may induce a user to a desired region to be promoted, or may disperse users in an excessively busy region to another region, using the event region 1010.

In an example, the mobile terminal 1090 may estimate a current location using a global positioning system (GPS) and a global navigation satellite system (GNSS). The mobile terminal 1090 may determine whether the estimated location is within the event region 1010. In another example, the mobile terminal 1090 may estimate a location of the mobile terminal 1090 via a communication with a beacon that stores coordinates of the beacon in advance. However, an estimation of the location of the mobile terminal 1090 is not limited thereto, and various location measurement technologies and location estimation technologies may be applied.

In another example, the mobile terminal 1090 may adjust a credit generation period and a credit generation amount based on a distance the mobile terminal 1090 moves within the service space 1000. The mobile terminal 1090 may reduce the credit generation period and increase the credit generation amount, in proportion to the distance the mobile terminal 1090 moves within the service space 1000.

In another example, the mobile terminal 1090 may assign a bonus credit to the ticket information in response to information associated with an achievement of an external event being collected. The external event may be an event planned for marketing of a service space and marketing of a predetermined attraction, and may include, for example, a promotional event such as an affiliate movie or an affiliate product associated with a service provider. The mobile terminal 1090 may determine that the external event is achieved through a barcode recognition of a purchase receipt for an affiliate product. However, the external event is not limited thereto. For example, the mobile terminal 1090 may assign a bonus credit to the ticket information in response to predesignated coupon information being received from a user.

Also, the mobile terminal 1090 may assign a bonus credit to the ticket information, based on user's personal information (for example, a residence). For example, when a user's residence is a geographic location adjacent to a service space, the mobile terminal 1090 may assign a bonus credit to the ticket information.

In the present specification, a bonus credit may be distinguished from a default credit and an additional credit and may refer to a credit assigned to ticket information when user's personal information satisfies a predetermined condition or when an external event is achieved. However, example embodiments are not limited thereto, and the bonus credit may be combined with the default credit and the additional credit. When the bonus credit is used, the attraction reservation management system may increase a probability of winning an attraction associated with the bonus credit. When a predetermined retention period (for example, 180 days) elapses, the bonus credit may be automatically excluded from the ticket information by a server and the mobile terminal 1090.

The attraction reservation management system may monitor cheating. When cheating associated with arbitrary ticket information is detected, the attraction reservation management system may perform an operation of applying a sanction to the ticket information.

For example, the server may determine whether the location of the mobile terminal 1090 is determined normally. The server may verify a location estimated by the mobile terminal 1090 and may determine whether the location is effectively estimated. When the mobile terminal 1090 estimates a location using a GNSS, the server may compare the location estimated based on the GNSS to a location estimated based on another scheme. The server may collect a geographic location corresponding to an Internet protocol (IP) address of the mobile terminal 1090 and a geographic location of a wireless access point (AP) accessed by the mobile terminal 1090, and may compare the collected geographic locations to the location estimated by the mobile terminal 1090. When a difference between the collected geographic locations and the location estimated by the mobile terminal 1090 exceeds a location error, the server may determine that the location of the mobile terminal 1090 is determined abnormally. However, a detection of cheating is not limited thereto, and various schemes may be used. For example, the mobile terminal 1090 may execute an application (for example, an application to detect a location manipulation) configured to monitor cheating.

In response to cheating being detected, the server may remove a credit assigned to the ticket information. For example, the server may remove any one or any combination of a default credit, an additional credit and a bonus credit assigned to ticket information by an amount of credits for restrictions. Also, the server may deactivate ticket information from which cheating is detected. However, a sanction operation is not limited thereto, and at least one of the server and the mobile terminal 1090 may perform various sanction operations based on a level of cheating.

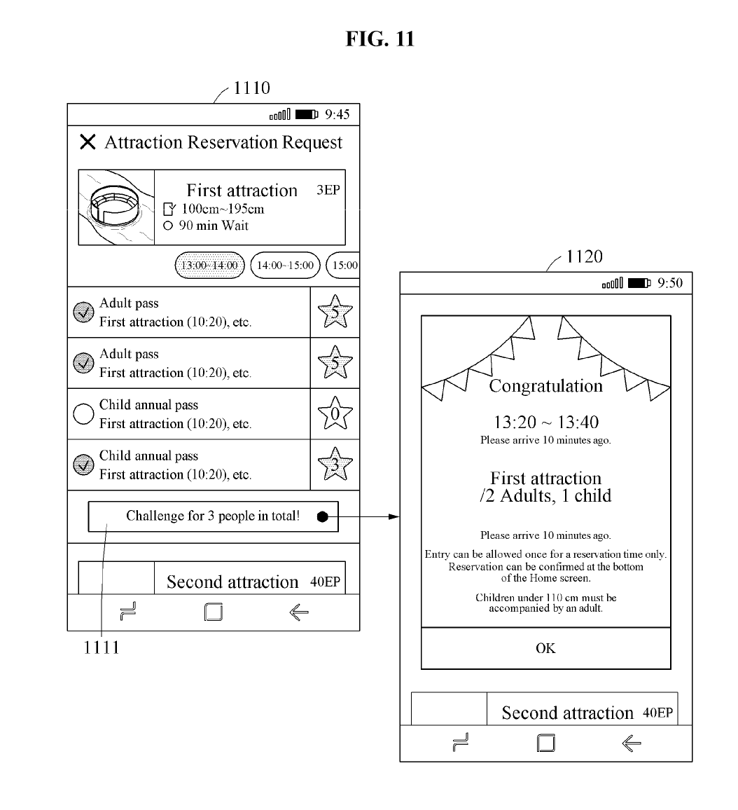

FIG. 11 illustrates a reservation request according to an example embodiment.

A mobile terminal may send a reservation request for a target attraction to a server in response to a user input. For example, the mobile terminal may acquire a user input using an attraction reservation management application.

FIG. 11 illustrates an example of an interface 1110 to send a reservation request. In response to a user input, the mobile terminal may designate a target attraction, a time slot of the target attraction and a number of people who will use the target attraction, and may generate a reservation request. In response to a user input associated with a reservation application object 1111, the mobile terminal may send the reservation request generated as described above to the server. For example, the mobile terminal may send, to the server, a reservation request for a time slot selected from time slots available for the target attraction in response to a user input. In FIG. 11, time slots may be classified in units of 1 hour, and a time slot of 13:00 to 14:00 is selected through the interface 1110.

When a reservation request is approved by the server, the mobile terminal may receive attraction reservation information from the server. The mobile terminal may visually display the received attraction reservation information, to notify a user of a reservation result 1120. For example, in response to a reservation request for a time slot of a target attraction being approved by the server, the mobile terminal may generate attraction reservation information indicating an interval designated by the server among a plurality of intervals into which the time slot is divided. As shown in the reservation result 1120, the server may generate attraction reservation information to designate an interval of 13:20 to 13:40 in a time slot of 13:00 to 14:00, and may provide the attraction reservation information to the mobile terminal. Thus, the server may properly disperse attraction reservations in units of intervals within a time slot, to reduce a user's waiting time. An interval may not be exposed to the mobile terminal until a reservation request is approved, and the server may internally manage the interval.

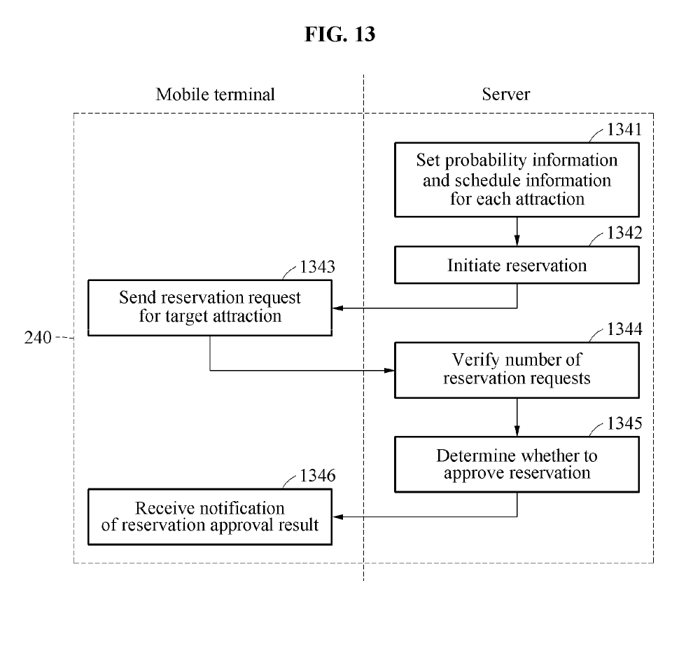

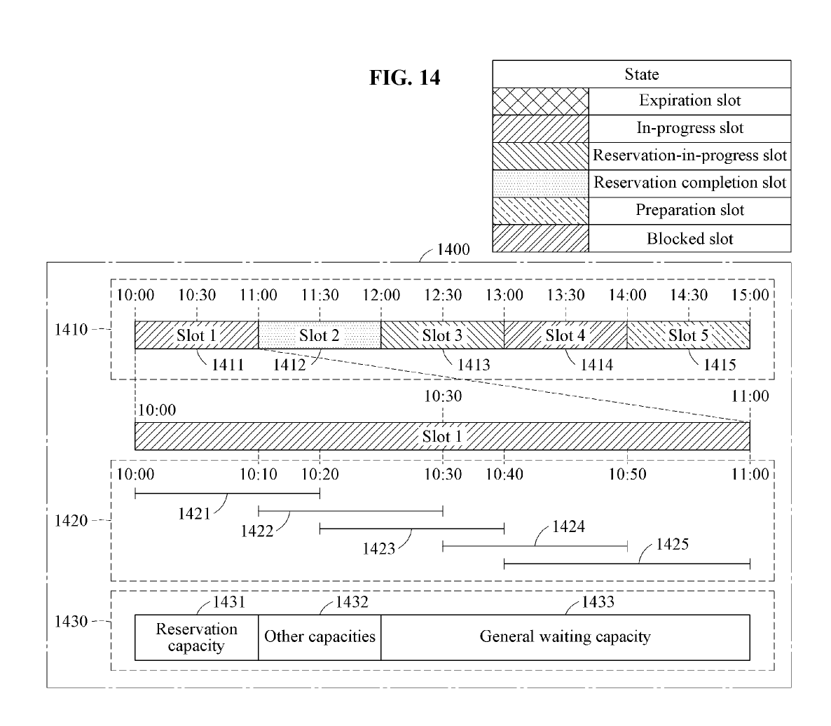

An approval of a reservation request by the server will be further described below with reference to FIG. 13, and a time slot and intervals will be further described below with reference to FIG. 14.

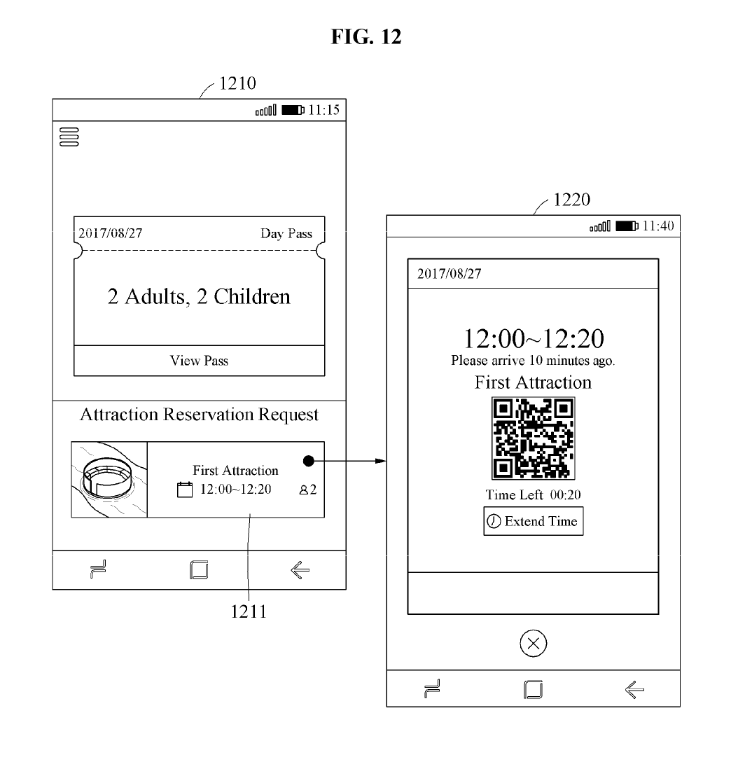

FIG. 12 illustrates attraction reservation information for an approved reservation request according to an example embodiment.

A mobile terminal may provide attraction reservation information mapped to ticket information together with the ticket information through a ticket information interface 1210. For example, in response to a user input associated with a reservation confirmation object 1211, the mobile terminal may visually display the attraction reservation information. The mobile terminal may visualize the attraction reservation information as a reserved ticket 1220. In FIG. 12, the reserved ticket 1220 may include information about a target attraction, a reserved interval for the target attraction, and a code for an entry (for example, a 2D code).

FIG. 13 is a flowchart illustrating an approval of a reservation according to an example embodiment.

FIG. 13 illustrates an example of operation 240 of FIG. 2.

In operation 1341, a server may set probability information and schedule information for each attraction. The schedule information may refer to a schedule associated with an operation of an attraction, and may include, for example, a plurality of time slots and intervals into which each of the time slots is divided. A time slot may refer to a unit of time obtained by dividing an operating hour of an attraction. The probability information may refer to a probability set for each time slot, and may include, for example, a probability of winning a reservation request for a corresponding time slot.

In operation 1342, the server may initiate a reservation. For example, the server may collect a plurality of reservation requests for a time slot of a target attraction during a reservation time corresponding to the time slot.

In operation 1343, a mobile terminal may send a reservation request for a target attraction to the server. The mobile terminal may designate a target attraction, a time slot indicating a time zone for which the target attraction is to be used, and a number of people desiring to use the target attraction, based on a user input. Also, the mobile terminal may send, to the server, a plurality of reservation requests based on the number of people desiring to use the target attraction.

In operation 1344, the server may verify a number of reservation requests. For example, the server may determine the number of reservation requests, based on a number of people desiring to use the target attraction.

In operation 1345, the server may determine whether to approve a reservation. The server may determine whether to approve each of a plurality of reservation requests collected during a reservation time. For example, in response to a capacity assigned to a time slot of the target attraction remaining, the server may approve a reservation request from the mobile terminal. Also, the server may determine whether to approve the reservation request based on a probability even when the capacity remains. When the reservation request is approved, the server may generate attraction reservation information.

Capacities assigned for each time slot of each attraction may be classified into a plurality of types based on a queue scheme provided to a user. For example, the capacities may be classified into a reservation capacity, other capacities and a general queue capacity. The general queue capacity may refer to a capacity provided to a user who waits in a line at a corresponding attraction, and the other capacities may refer to capacities preserved for an arbitrary purpose. The reservation capacity may refer to a capacity provided for a reservation service by the above-described reservation request.

In operation 1346, the mobile terminal may receive a notification of a reservation approval result from the server. For example, the server may transmit attraction reservation information to the mobile terminal. The mobile terminal may display the attraction reservation information to notify a user of the reservation approval result.

FIG. 14 is a diagram illustrating schedules, time slots and intervals of a target attraction according to an example embodiment.

An attraction reservation management system may manage schedule information 1400 of an individual attraction. The schedule information 1400 may be information associated with a schedule of an attraction, and may include information 1410 associated with time slots, information 1420 associated with intervals, and information 1430 associated with capacities.

The information 1410 may indicate a start time and an end time of an individual time slot. A time slot may refer to a unit of time obtained by regularly dividing an operating hour of an attraction. The information 1420 may indicate a start time and an end time of an individual interval. An interval may refer to a unit of time obtained by dividing a time slot. The information 1430 may indicate a number of people to be accommodated in an attraction for each time slot.

In FIG. 14, the information 1410 may include, for example, a first time slot 1411, a second time slot 1412, a third time slot 1413, a fourth time slot 1414 and a fifth time slot 1415. Time slots may be classified as an expiration slot, an in-progress slot, a reservation-in-progress slot, a reservation completion slot, a preparation slot and a blocked slot. The expiration slot may indicate that an end time of a time slot has already elapsed. The in-progress slot may indicate that a current time is between a start time and an end time of a time slot. The reservation-in-progress slot may indicate that a current time is between a start time and an end time of a reservation time. The reservation completion slot may refer to a slot in which a capacity is completely used. The preparation slot may refer to a slot that has not yet been reserved. The blocked slot may refer to a slot of which a reservation is arbitrarily limited by a service provider.

For example, a time slot may represent a unit of 1 hour. In FIG. 14, the first time slot 1411 may represent a time period from 10:00 to 11:00, the second time slot 1412 may represent a time period from 11:00 to 12:00, the third time slot 1413 may represent a time period from 12:00 to 13:00, the fourth time slot 1414 may represent a time period from 13:00 to 14:00, and the fifth time slot 1415 may represent a time period from 14:00 to 15:00. Intervals of the first time slot 1411 are described below.

A time slot may be divided into a plurality of intervals. For example, the first time slot 1411 may be divided into a first interval 1421, a second interval 1422, a third interval 1423, a fourth interval 1424 and a fifth interval 1425. Each of the intervals of the time slot may partially overlap at least one interval. For example, the first interval 1421 may represent a time period from 10:00 to 10:20, the second interval 1422 may represent a time period from 10:10 to 10:30, the third interval 1423 may represent a time period from 10:20 to 10:40, the fourth interval 1424 may represent a time period from 10:30 to 10:50, and the fifth interval 1425 may represent a time period from 10:40 to 11:00. However, the intervals are not limited thereto.

A mobile terminal may generate a reservation request for each time slot in response to a user input. A server may determine whether to approve a reservation request for a time slot of a target attraction. In response to the reservation request being approved, the server may determine one of a plurality of intervals into which the time slot is divided. The server may generate attraction reservation information indicating the determined interval. The server may provide the attraction reservation information as ticket information. The attraction reservation management system may properly distribute users based on intervals of a time slot desired by users while accepting reservations for the desired time slot. Thus, the attraction reservation management system may efficiently minimize a user's waiting time by preventing a number of users from increasing in a predetermined time slot.

The information 1430 may indicate capacities for each time slot. For example, a capacity may include a reservation capacity 1431, other capacities 1432 and general waiting capacity 1433, however, is not limited thereto. A ratio of capacities may be adjusted by the server, and capacities may be set differently for each time slot and for each attraction.

The server may store and maintain the schedule information 1400. For example, the server may load the schedule information 1400 that is set in advance for a predetermined period (for example, a festival period), and may set a time slot and an interval for an individual attraction.

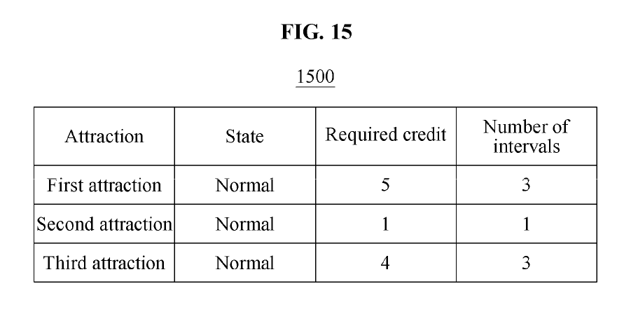

FIG. 15 illustrates credit-related information 1500 of a target attraction according to an example embodiment.

The credit-related information 1500 may include information associated with a credit required for a reservation of an individual attraction. Also, the credit-related information 1500 may further include a number of intervals into which a time slot of each individual attraction is divided. In the credit-related information 1500, a required credit may indicate a minimum amount of credits required for a reservation of a corresponding attraction.

For example, referring to FIG. 15, “5” credits are required for a reservation for a first attraction and “3” intervals are provided. In this example, a mobile terminal may generate a reservation request for the first attraction by subtracting at least “5” credits from credits that are cumulatively assigned to ticket information, so that a user may request a reservation for the first attraction. The mobile terminal may send the reservation request for the first attraction to a server. When a reservation request for an arbitrary time slot of the first attraction is approved, the server may select one of “3” intervals into which the time slot is divided and may provide attraction reservation information as ticket information to the mobile terminal. The attraction reservation information stored in the mobile terminal may include, for example, information about a ticket reserved to be used for the first attraction in an interval designated by the server within a time slot selected by a user.

FIG. 16 illustrates information 1600 associated with a probability and a capacity of a target attraction according to an example embodiment.

Referring to FIG. 16, the information 1600 may include a time period of a time slot, a reservation time, capacities, and a reservation restriction. However, example embodiments are not limited thereto and the information 1600 is merely an example.

A service provider may set a reservation time during which a reservation service is open to a customer for each time slot of an individual attraction. A user may verify which attraction that the user may make a reservation, and may request a reservation for a target attraction using credits that are cumulatively assigned to ticket information during a reservation time.

A capacity may include, for example, a reservation capacity and a general capacity as shown in FIG. 16. The reservation capacity may refer to a capacity of an attraction provided to a reservation service, and the general capacity may refer to a capacity provided for waiting and may be managed as a ratio (for example, %) in FIG. 16. Although the same ratio of the capacity for all time slots is set as shown in FIG. 16, example embodiments are not limited thereto. A server may adjust a ratio of each of the general capacity and the reservation capacity based on a time zone. Also, the server may adjust a ratio of capacities for each attraction.

A winning probability may refer to a probability set for a reservation request for an arbitrary time slot of an attraction. The server may determine whether to sequentially approve a plurality of reservation requests for a time slot of a target attraction based on a predetermined probability. The server may repeat an approval for each of the plurality of reservation requests until a capacity assigned to the time slot is satisfied. For example, when a winning probability is set to 100% as shown in FIG. 16, the server may sequentially approve a plurality of reservation requests on a first-come-first-serve basis.

A reservation restriction may refer to a time in which consecutive reservations for each attraction are restricted. For example, the server may exclude a reservation request that is based on ticket information including already generated attraction reservation information for an attraction during an amount of time corresponding to the reservation restriction. Referring to FIG. 16, when a reservation request based on arbitrary ticket information is approved, the server may exclude another reservation request based on the ticket information before 30 minutes elapse from a point in time at which the reservation request is approved. When the reservation restriction is cancelled, for example, when an amount of time corresponding to the reservation restriction elapses, the server may accept, again, a reservation request that is based on a subtraction of credits that are cumulatively assigned to the ticket information.

Although a probability is set in advance as shown in FIG. 16, example embodiments are not limited thereto. The probability may be determined based on a number of reservation requests and a capacity of a time slot of an attraction. For example, the server may calculate a probability based on a plurality of reservation requests for a time slot of a target attraction and a capacity assigned to a time slot. In this example, the probability may be expressed as, for example, “probability=max(1, Time slot capacity/Number of collected reservation requests).” The server may determine whether to approve each of the plurality of reservation requests based on the calculated probability.

An attraction reservation management system may determine whether to approve a reservation request based on a first-come-first-serve basis scheme, a probability scheme, or a combination thereof.

In an example, a processor of the server may determine a probability based on an amount of credits subtracted for a reservation request. The server may determine whether to approve a reservation request based on the determined probability. A mobile terminal may increase a winning probability for an attraction by increasing the amount of credits subtracted for the reservation request. Based on the amount of credits subtracted for the reservation request, the server may proportionally or gradually raise the probability. For example, when the amount of credits subtracted exceeds a threshold credit and when an attraction has a sufficient capacity, the server may approve a corresponding reservation request instead of calculating a probability.

In another example, when a bonus credit is included in credits subtracted for a reservation request, the server may increase a probability. The bonus credit may refer to a credit added to ticket information through an external event, for example, a coupon registration as described above. The mobile terminal may supplement an existing credit with the bonus credit, however, example embodiments are not limited thereto. The mobile terminal may correct a winning probability by use of the bonus credit. The correcting of the winning probability may include, for example, a 10% increase, a 50% increase, and a guarantee of 50% and 100%.

Also, the attraction reservation management system may determine whether to approve an individual reservation request based on an amount of credits subtracted for a reservation request. For example, the attraction reservation management system may approve reservation requests in a descending order of amounts of credits subtracted. The attraction reservation management system may first approve a reservation request corresponding to a largest amount of credits subtracted, followed by approving a reservation request corresponding to a second largest amount of credits subtracted. Thus, the attraction reservation management system may determine whether to approve reservation requests in a descending order of amounts of credits subtracted.

The attraction reservation management system may use the same scheme to determine whether to approve reservation requests for all attractions, however, example embodiments are not limited thereto. Accordingly, the attraction reservation management system may determine whether to approve reservation requests for at least a portion of a plurality of attractions using a different scheme from a scheme of determining whether to approve reservation requests for the remaining attractions. For example, the attraction reservation management system may approve reservation requests for a first attraction on the first-come-first-serve basis, may approve reservation requests for a second attraction using the probability scheme, and may approve reservation requests for a third attraction in a descending order of amounts of credits subtracted.

The attraction reservation management system may use the same scheme to determine whether to approve reservation requests for all time slots, however, example embodiments are not limited thereto. Accordingly, the attraction reservation management system may determine whether to approve reservation requests for at least a portion of a plurality of time slots using a different scheme from a scheme of determining whether to approve reservation requests for the remaining time slots. For example, the attraction reservation management system may approve reservation requests for a first time slot corresponding to a relatively small number of users on the first-come-first-serve basis, and may approve reservation requests for a second time slot corresponding to a relatively large number of users using the probability scheme.

Although the credit-related information 1500 and the information 1600 are separately illustrated for convenience of description, example embodiments are not limited thereto. Accordingly, the attraction reservation management system may also manage a database that includes all an amount of credits required for a reservation for an attraction, a number of intervals of a time slot of an individual attraction, a time period of a time slot, a reservation time, a capacity, and a reservation restriction. The server in the attraction reservation management system may set any one or any combination of a capacity of a target attraction, a minimum amount of credits required for a target attraction, state information of a target attraction and reservation restriction information of a target attraction, based on the above preset database.

Also, the attraction reservation management system may adjust a default credit and additional credit-related information of individual ticket information in response to an operation of a service provider. For example, when the default credit and the additional credit-related information are adjusted in response to an operation of a service provider, the server may assign the adjusted default credit and the adjusted additional credit-related information to ticket information with credits that are to be adjusted. For example, when a credit of ticket information of a VIP class is adjusted, the server may assign the adjusted credit to the ticket information.

FIG. 17 is a block diagram illustrating a configuration of the mobile terminal 1700 according to an example embodiment.

Referring to FIG. 17, the mobile terminal 1700 may include an input acquirer 1710, a display 1720, a processor 1730, a memory 1740 and a communicator 1750.

The input acquirer 1710 may receive a user input associated with ticket information from a user. The user input may be an input acquired from the user, and may include, for example, an input (hereinafter, referred to as a “touch input”) by touching the display 1720, a mouse click, and a character input. A user input associated with an object visualized on the display 1720 may refer to an input to activate a command assigned to the object. The object may be visualized on the display 1720 by a graphical representation. For example, the input acquirer 1710 may acquire a user input (for example, an input of a serial number, or a recognition of a QR code) to register a ticket in the mobile terminal 1700.

The display 1720 may visualize various interfaces provided by an attraction reservation management application. Also, the display 1720 may visualize ticket information acquired from a user and attraction reservation information received from a server.

Although the input acquirer 1710 and the display 1720 are separate as shown in FIG. 17, example embodiments are not limited thereto. For example, the input acquirer 1710 to acquire a touch input and the display 1720 to visualize a screen may be integrated to implement a touch screen.

The processor 1730 may activate ticket information input by the user input in response to an entry based on the ticket information being approved. The processor 1730 may assign a default credit and additional credit-related information to the ticket information in response to an activation of the ticket information. The processor 1730 may assign an additional credit to the ticket information in response to an amount of time based on the additional credit-related information elapsing. The processor 1730 may generate attraction reservation information for a target attraction by subtracting a cumulative credit. However, an operation of the processor 1730 of the mobile terminal 1700 is not limited thereto, and the processor 1730 may perform at least one of the operations described above with reference to FIGS. 1A through 16.

The memory 1740 may temporarily or semi-permanently store data used to perform an attraction reservation management method. For example, the memory 1740 may store ticket information and attraction reservation information. Also, the memory 1740 may store an attraction reservation management application.

The communicator 1750 may transmit data to an external device or may receive data from the external device. In an example, the communicator 1750 may communicate with a server. The communicator 1750 may transmit, to the server, ticket information, and a reservation request for a target attraction based on the ticket information. The communicator 1750 may receive, from the server, a default credit, additional credit-related information, and attraction reservation information. In another example, the communicator 1750 may communicate with an intermediate terminal, and may transmit ticket information, and a reservation request for a target attraction based on the ticket information via the intermediate terminal to the server. The communicator 1750 may receive a default credit, additional credit-related information, and attraction reservation information via the intermediate terminal from the server.

The operations of the input acquirer 1710, the display 1720, the processor 1730, the memory 1740 and the communicator 1750 in the mobile terminal 1700 are not limited to those described above, and the mobile terminal 1700 may perform the operations described above with reference to FIGS. 1A through 16.

Also, the configuration of the mobile terminal 1700 shown in FIG. 17 is merely an example, and example embodiments are not limited thereto.

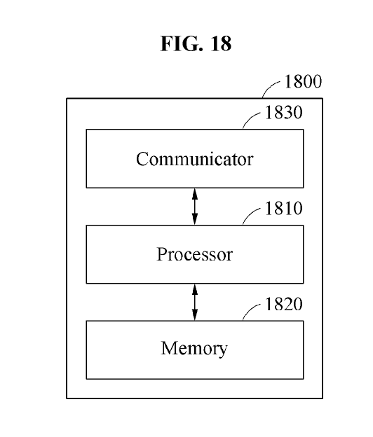

FIG. 18 is a block diagram illustrating a configuration of a server 1800 according to an example embodiment.

Referring to FIG. 18, the server 1800 may include a processor 1810, a memory 1820 and a communicator 1830.

The processor 1810 may activate ticket information in response to an entry based on the ticket information being valid. The processor 1810 may assign a default credit and additional credit-related information to the ticket information in response to an activation of the ticket information. The processor 1810 may assign an additional credit to the ticket information in response to an amount of time based on the additional credit-related information elapsing. The processor 1810 may determine whether to approve a reservation request based on a capacity of a target attraction. The processor 1810 may generate attraction reservation information for the target attraction in response to the reservation request being approved.

The memory 1820 may temporarily or semi-permanently store data used to perform an attraction reservation management method. For example, the memory 1820 may include a database that is configured to manage a cumulative credit amount for each personal ticket, a credit generation period and a credit generation amount. The memory 1820 may store table data (for example, the credit-related setting set 900 of FIG. 9) indicating a default credit and additional credit-related information mapped for each attribute information (for example, a class of a ticket or age categories of customers). Also, the memory 1820 may store table data (for example, the credit-related information 1500 of FIG. 15 and the information 1600 of FIG. 16) indicating a minimum amount of credits required for a reservation for each attraction, a time slot, a number of intervals, a reservation time, a capacity, a probability, a reservation restriction and a state. However, data stored in the memory 1820 is not limited thereto.

The communicator 1830 may communicate with a mobile terminal and an entry gate. For example, the communicator 1830 may receive, from the mobile terminal, a request to activate ticket information registered in the mobile terminal, and a reservation request based on a subtraction of credits that are cumulatively assigned to ticket information. Also, the communicator 1830 may receive, from the entry gate, ticket information of the mobile terminal recognized by the entry gate.

The operations of the processor 1810, the memory 1820 and the communicator 1830 in the server 1800 are not limited to those described above. The server 1800 may perform the operations described above with reference to FIGS. 1A through 16.

Also, the configuration of the server 1800 shown in FIG. 18 is merely an example, and example embodiments are not limited thereto.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A mobile terminal comprising:
an input acquirer configured to receive a user input associated with ticket information from a user;
a processor configured to activate the ticket information input by the user input in response to an entry based on the ticket information being approved, configured to assign a default credit and additional credit-related information to the ticket information in response to an activation of the ticket information, configured to assign an additional credit to the ticket information in response to an amount of time based on the additional credit-related information elapsing, and configured to generate attraction reservation information for a target attraction by subtracting a cumulative credit calculated by accumulating the default credit and the additional credit; and
a memory configured to store the ticket information and the attraction reservation information.

2. The mobile terminal of claim 1, wherein the processor is configured to:
send, to a server, a request for a default credit and additional credit-related information determined based on attribute information of the ticket information; and
assign the determined default credit and the determined additional credit-related information to the ticket information in response to an approval for the request by the server.

3. The mobile terminal of claim 1, wherein the processor is configured to receive, from a server, additional credit-related information indicating a credit generation period and a credit generation amount, and to assign an additional credit corresponding to the credit generation amount to the ticket information every time the credit generation period elapses from a point in time at which the ticket information is activated based on the additional credit-related information.

4. The mobile terminal of claim 1, wherein the processor is configured to deactivate the ticket information in response to the mobile terminal being out of a region defined as a service space.

5. The mobile terminal of claim 1, wherein the processor is configured to adjust at least one of a credit generation period and a credit generation amount provided to the ticket information when the mobile terminal is being located within an event region.

6. The mobile terminal of claim 1, wherein the processor is configured to assign a bonus credit to the ticket information in response to information associated with an achievement of an external event being collected.

7. The mobile terminal of claim 1, wherein the processor is configured to determine an amount of credits to be subtracted for a reservation request for the target attraction in response to a user input.

8. The mobile terminal of claim 1, wherein the processor is configured to transmit, to a server, a reservation request for a time slot selected from time slots available for the target attraction in response to a user input.

9. The mobile terminal of claim 1, wherein the processor is configured to generate attraction reservation information indicating an interval designated by a server among a plurality of intervals into which a time slot of the target attraction is divided in response to a reservation request for the time slot being approved by a server.

10. A server comprising:
a communicator configured to receive an activation request for ticket information registered in a mobile terminal and a reservation request that is based on a subtraction of credits that are cumulatively assigned to the ticket information; and
a processor configured to activate the ticket information in response to an entry based on the ticket information being valid, configured to assign a default credit and additional credit-related information to the ticket information in response to an activation of the ticket information, configured to assign an additional credit to the ticket information in response to an amount of time based on the additional credit-related information elapsing, configured to determine whether to approve the reservation request based on a capacity of a target attraction, and configured to generate attraction reservation information for the target attraction in response to the reservation request being approved.

11. The server of claim 10, wherein the processor is configured to collect a plurality of reservation requests for a time slot of the target attraction during a reservation time corresponding to the time slot, and to determine whether to approve each of the plurality of reservation requests.

12. The server of claim 10, wherein the processor is configured to:
calculate a probability based on a plurality of reservation requests for a time slot of the target attraction and a capacity assigned to the target slot; and
determine whether to approve each of the plurality of reservation requests based on the calculated probability.

13. The server of claim 10, wherein the processor is configured to:
determine whether to sequentially approve a plurality of reservation requests for a time slot of the target attraction, based on a predetermined probability; and
repeat an approval of each of the plurality of reservation requests until a capacity assigned to the target slot is satisfied.

14. The server of claim 10, wherein the processor is configured to:
determine a probability based on an amount of credits to be subtracted for the reservation request; and
determine whether to approve the reservation request based on the determined probability.

15. The server of claim 10, wherein the processor is configured to:
determine additional credit-related information based on at least one of a date and attribute information of the ticket information; and
assign the determined additional credit-related information to the ticket information.

16. The server of claim 10, wherein the processor is configured to:
determine whether to approve a reservation request for a time slot of the target attraction;
determine one interval among a plurality of interval into which the time slot is divided in response to the reservation request being approved; and
assign attraction reservation information indicating the determined interval to the ticket information.

17. The server of claim 10, wherein the processor is configured to set any one or any combination of the capacity of the target attraction, a minimum amount of credits required for the target attraction, state information of the target attraction, and reservation restriction information for the target attraction.

18. The server of claim 10, wherein the processor is configured to deactivate the ticket information in response to a service end time elapsing.

19. An attraction reservation management method comprising:
activating ticket information registered in a mobile terminal in response to an entry based on the ticket information being allowed;
assigning a default credit and additional credit-related information to the ticket information in response to an activation of the ticket information;
assigning an additional credit based on the additional credit-related information to the ticket information in response to an amount of time elapsing; and
generating attraction reservation information for a target attraction by subtracting credits cumulatively assigned to the ticket information.

20. A non-transitory computer-readable storage medium storing at least one program comprising instructions that, when executed by a processor, cause the processor to perform the attraction reservation management of claim 19.
